(19) United States
(12) Patent Application Publication
(10) Pub. No.: US 2005/0195926 A1
(43) Pub. Date: Sep. 8, 2005

(54) Device and method for carrying out correlations in a mobile radio system

(76) Inventors: Thomas Ruprich, Munchen (DE); Steffen Paul, Baierbrunn (DE); Burkhard Becker, Ismaning (DE); Thuyen Le, Schonaich (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/076,094

(22) Filed: Mar. 9, 2005

Related U.S. Application Data
(63) Continuation of application No. PCT/DE03/02814, filed on Aug. 22, 2003.

(30) Foreign Application Priority Data
Sep. 9, 2002 (DE) DE 102 41 691.5

(51) Int. Cl. H04L 27/06

(52) U.S. Cl. 375/343

(57) ABSTRACT

A device (11) for carrying out a correlation, having a data memory (12) for storage of a sequence of sample values (110), having an address generator (13) for production of addresses for reading a data word (111), in which the sequence of sample values in the data word (111) need not be chronological, having a code generator (15) for production of a correlation word (112) from sequence elements in a correlation sequence, with the sequence elements being arranged in the correlation word (112) in a sequence which depends on the data word (111), and having a correlator unit (14).

### REFERENCE TO RELATED APPLICATION

This application is a continuation of PCT/DE03/02814, which was not published in English, which claims the benefit of the priority date of German Patent Application No. DE 102 41 691.5, filed on Sep. 9, 2002, the contents of which both are herein incorporated by reference in their entireties.

### FIELD OF THE INVENTION

The invention relates to a device and a method for carrying out correlations in a mobile radio system, in which data is interchanged by radio between a base station and at least one mobile radio.

### BACKGROUND OF THE INVENTION

Various tasks in mobile radio systems are processed with the aid of correlation procedures. The aim of the correlation procedures is generally to compare incoming data, which is in the form of sampled received signals in the receiver, with a sequence of data items which are known in the receiver. A correlation signal which is obtained from this comparison indicates, inter alia, whether the sequence of known data items in the received signal has been identified. The correlation procedures can also be used to obtain information about the time offset between the received signal and a predetermined timing.

One example of the use of correlation procedures in mobile radio systems is time slot and frame synchronization. In mobile radio systems, data is generally transmitted between the base station and the mobile radio receiver using a time slot and frame structure. Time synchronization between the base station and the mobile radio receiver is required in order to operate the mobile radio system. The synchronization of the mobile radio receiver that is required for this purpose is carried out, inter alia, when the mobile radio receiver is switched on or during a handover to a new cell. In this case, a distinction is drawn between time slot synchronization and frame synchronization. The aim of time slot synchronization is to find time slot boundaries. Once the time slot boundaries have been found, frame synchronization can be carried out. In this case, the start of a frame is looked for.

Predetermined synchronization codes, which each comprise a sequence of chips, are transmitted by each base station at the start of each time slot and are available in the mobile radio receiver are used for time slot synchronization and frame synchronization. The received synchronization codes are correlated in the mobile radio receiver with the known synchronization codes. The time slot boundaries and frame boundaries are determined from the correlation results.

The time slot synchronization code which is used for time slot synchronization is also referred to as the primary synchronization code (pSC). The frame synchronization code which is used for frame synchronization is also referred to as the secondary synchronization code (sSC).

In the UMTS (Universal Mobile Telecommunications System) Standard, the time slot synchronization code pSC comprises 256 chips, and has the following structure:

$$\begin{matrix}\begin{matrix}pSC = < a , a , a , - a , - a , a , - a , - a , a , a , a , - a , a , - a , a , a > \\ = a < 1 , 1 , 1 , - 1 , - 1 , 1 , - 1 , - 1 , 1 , 1 , 1 , - 1 , 1 , - 1 , 1 , 1 >\end{matrix} & ( a ) \\ \begin{matrix}a = ( 1 + j ) < 1 , 1 , 1 , 1 , 1 , 1 , - 1 , - 1 , 1 , - 1 , 1 , - 1 , 1 , - 1 , - 1 , 1 > \\ ( 1 + j ) < a ( 0 ) , a ( 1 ) , a ( 2 ) , a ( 3 ) , a ( 4 ) , a ( 5 ) , a ( 6 ) , a ( 7 ) , a ( 8 ) , \\ a ( 9 ) , a ( 10 ) , a ( 11 ) , a ( 12 ) , a ( 13 ) , a ( 14 ) , a ( 15 ) >\end{matrix} & ( b )\end{matrix}$$

In this case, the complex-value basic sequence a is produced from a sequence of 16 correlation coefficients a(n) (n=0, 1, . . . , 15), which may each assume either the value +1 or the value −1. Each of the correlation coefficients a(n) represents one chip.

The time slot synchronization code pSC comprises a sequence of 16 sequence elements. Each sequence element is in turn based on the basic sequence a which is in each case multiplied either by +1 or by −1. In consequence, the time slot synchronization code pSC has a total of 256 correlation coefficients a(n) or chips.

According to the UMTS Standard, a frame synchronization code sSC comprises 256 chips. Each frame synchronization code sSC is obtained from positionwise multiplication of a generating Hadamard sequence by a sequence z which is common to all the frame synchronization codes sSC and is constructed as follows:

$$\begin{matrix}\begin{matrix}z = < b , b , b , - b , b , b , - b , - b , b , - b , b , - b , - b , - b , - b , - b > \\ = b < 1 , 1 , 1 , - 1 , 1 , 1 , - 1 , - 1 , 1 , - 1 , 1 , - 1 , - 1 , - 1 , - 1 , - 1 , >\end{matrix} & ( c ) \\ \begin{matrix}b = ( 1 + j ) < 1 , 1 , 1 , 1 , 1 , 1 , - 1 , - 1 , - 1 , 1 , - 1 , 1 , - 1 , 1 , 1 , - 1 > \\ = ( 1 + j ) < b ( 0 ) , b ( 1 ) , b ( 2 ) , b ( 3 ) , b ( 4 ) , b ( 5 ) , b ( 6 ) , b ( 7 ) , b ( 8 ) , b ( 9 ) , \\ = b ( 10 ) , b ( 11 ) , b ( 12 ) , b ( 13 ) , b ( 14 ) , b ( 15 ) >\end{matrix} & ( d )\end{matrix}$$

In this case, the complex-value basic sequence b is produced from a sequence of 16 correlation coefficients b(n) (n=0, 1, . . . , 15), each of which may assume either the value +1 or the value −1. Each of the correlation coefficients b(n) represents one chip.

The sequence z comprises a sequence of 16 sequence elements. Each sequence element is in turn based on the basic sequence b, which is in each case multiplied either by +1 or by −1. In consequence, the sequence z has a total of 256 correlation coefficients b(n) or chips.

The positionwise multiplication of the sequence z by 16 different Hadamard sequences each comprising 256 chips results in 16 different frame synchronization codes, each having 256 chips. The base station transmits one specific frame synchronization code in each time slot in a frame. The sequence of the frame synchronization codes is the same in each frame, for a given base station. The frame start can also be deduced from the pattern of frame synchronization codes, which thus results in each frame. Furthermore, this pattern is characteristic of each base station, and is thus also used to determine the base station transmitting the frame synchronization codes.

During the time slot synchronization process, the chips from the time slot synchronization codes arriving in the mobile radio receiver, or their sample values, are correlated with the known time slot synchronization code, for example with the aid of a matched filter. The matched filter carries out successive correlation procedures over 256 sample values, with the offset between two successive correlation procedures corresponding, for example, to half the chip length. According to the UMTS Standard, one time slot contains 2560 chips, so that the matched filter normally calculates 5120 correlation values in each time slot.

After completion of the correlation processes which are required for time slot synchronization, the correlations for frame synchronization are carried out. The start indices which resulted in the highest correlation values during the time slot synchronization process are used, for example, as the start indices for these correlation processes. Beginning with a start index, 256 sample values are multiplied positionwise by the sequence z for frame synchronization. In parallel with this, the sum is formed of the multiplication results from 16 successive sample values in each case, thus resulting in 16 partial correlation values. A partial correlation value corresponds to correlation of the 16 sample values processed in the partial correlation value with the basic sequence b on which the sequence z is based. The mathematical sign +1 or −1 by which the basic sequence b is multiplied as a function of its position in the sequence z must be taken into account in this process. Overall, in consequence, this results in 16 complex-value partial correlation values for a start index.

The configuration of a frame synchronization code sSC comprising the sequence z and a Hadamard sequence means that the 16 complex-value partial correlation values also have to be subjected to a 16-point Hadamard transformation.

In order to carry out the correlation processes described above, the synchronization code sample values received by the mobile radio receiver are generally first of all temporarily stored in a data memory and are then supplied to the matched filter for correlation. Once a correlation process has been carried out over 256 sample values, a new start index is defined, starting from which a correlation value is once again calculated from 256 sample values. This procedure has the disadvantage that, before the start of a new correlation process, the sample values stored in the data memory must be reorganized in a suitable manner for carrying out the correlation process. For example, the reorganization may be carried out by means of a shift register. In the minimum case, 256 sample values would have to be shifted for such reorganization. This would result in a high power consumption for the data memory.

### SUMMARY OF THE INVENTION

The present invention provides devices and methods for carrying out a correlation in a mobile radio system, which is distinguished by low power consumption. The devices and methods are useable for time slot synchronization and frame synchronization in the UMTS Standard.

In accordance with an aspect of the invention, a device, which is used for carrying out correlation processes in a mobile radio system, has a data memory, an address generator, a code generator and a correlator unit.

A received signal is sampled and the sample values obtained from this are read in the sequence in which they are being recorded to the data memory, where they are stored.

The following text analyzes the correlation (which is carried out in the device according to the invention) of a data word, which contains the sample values of a cohesive section of the sequence of sample values.

The addresses which are required for reading the data word from the data memory are generated by the address generator in accordance with a predetermined reading rule. In this case, the sequence in which the sample values are arranged in the data word need not necessarily be the same as the sequence in which the sample values were recorded. In fact, the sequence of the sample values within the data word is governed by the sequence of the sample values within the section, the reading rule and the organization structure of the data memory.

A correlation word with which the data word is intended to be correlated is produced by the code generator from the sequence elements in a cohesive section of a predetermined correlation sequence. The sequence in which the sequence elements are arranged in the correlation word depends on the data word. Finally, the correlator unit correlates the data word with the correlation word.

In previous correlation devices for mobile radio systems, only a specific number of different correlation words have been used for the correlations of the data words, which contain the sample values. The correlation words are fixed from the start. Before carrying out a correlation, the sample values were reorganized in the data memory in previous correlation devices, such that the data word required for the correlation is obtained from this by a single relatively simple reading step, in which the sample values are arranged in the sequence in which they were recorded.

It is noted that the present invention does not require reorganization of the sample values in the data memory before a correlation process. Instead of this, the sample values are, by way of example, read from the data memory in a similar manner to that in which they were initially found there. This means that the sequence of the sample values in which they were recorded is not the sole governing factor for the sequence in which the sample values are arranged in the data word. In addition, the reading rule and the organization structure of the data memory are also responsible for the arrangement of the sample values in the data word. Since the sequence of the sample values in the data word no longer necessarily corresponds to their chronological sequence, the sequence elements in the correlation sequence have to be arranged in the correlation word corresponding to the arrangement of the sample values in the data word.

Overall, the procedure according to the invention results in a considerable power saving during operation of the correlation device, since the number of sequence elements arranged in the correlation word is in general considerably less than the number of sample values stored in the data memory so that reorganization of the sequence elements in the correlation word involves considerably less effort than reorganization of the sample values in the data memory.

The data memory is advantageously formed from M separately addressable memory elements.

When reading the sample values to the data memory, the sample values are preferably read sequentially and cyclically to the memory elements. N successively recorded sample values are thus read to one memory element, and the subsequent N sample values are read to the next memory element. Once all of the memory elements have been run through once, the reading procedure starts again with the first memory element.

By way of example, with this reading procedure, it is possible to provide for only one sample value to be read to each memory element in each run through the memory elements, that is to say for N to be equal to 1.

According to one refinement of the invention, the correlation sequence is based on a basic sequence. For example, in the case of a correlation process for UMTS time slot synchronization, this may be the basic sequence a from the equation (2) or, in the case of a correlation process for UMTS frame synchronization, the basic sequence b from the equation (4).

The correlation word can be produced by running through the basic sequence cyclically, starting at one sequence element. One particularly preferred refinement of the invention provides for the data word to comprise M sample values, and for the basic sequence to comprise M sequence elements. Furthermore, one and only one sample value from each memory element is allocated to the data word.

The memory elements can be numbered successively on an imaginary basis from 1 to M. While complying with the particularly preferred refinement of the invention described above, the sample values in the data word can likewise be numbered successively from 1 to M. If one data word subunit is allocated to each of these sample values, then the data word subunits can likewise be numbered successively, on an imaginary basis, from 1 to M. A further refinement of the invention is characterized in that the address generator presets a start address X, which denotes one memory element, for reading the data word in accordance with the reading rule. The sample values which are stored in the memory elements X to M are assigned to the data word subunits X to M, and the sample values which are stored in the memory elements 1 to X-1 are assigned to the data word subunits 1 to X-1. This is based on the assumption that the sample values stored in the memory elements X, . . . ,M,1, . . . ,X-1 have been recorded successively in the stated sequence. This measure represents one possible way to allocate the sample values to the data word, subject to the given preconditions.

According to the invention, the arrangement of the sequence elements in the correlation word must be matched to the arrangement of the sample values in the data word. For this purpose, the sequence elements in the basic sequence can first of all be numbered successively, on an imaginary basis, from 1 to M as well. It is also possible to provide for the correlation word to comprise correlation word subunits, to each of which one sequence element is allocated, and which are likewise numbered successively, on an imaginary basis, from 1 to M. The values for the correlation word subunits X to M are then preferably produced from the sequence elements 1 to M-(X-1) from the basic sequence, and the values for the correlation word subunits 1 to X-1 are produced from the sequence elements M-(X-1)+1 to M from the basic sequence.

One further aspect of the invention provides for the correlation sequence to be composed of a serial sequence of basic sequences, with the basic sequences each having a mathematical sign applied to them, which is predetermined by a complementary sequence. If, by way of example, the correlation is used for time slot synchronization in the UMTS Standard, then the correlation sequence is obtained from the time slot synchronization code pSC, the basic sequence is obtained from the basic sequence a from the above equation (2), and the complementary sequence is obtained from the mathematical sign sequence from the above equation (1). The correlation process may, for example, also be carried out for the purpose of frame synchronization in the UMTS Standard. In this case, the correlation sequence is obtained from the frame synchronization codes sSC, the basic sequence is obtained from the basic sequence b from the equation (4), and the complementary sequence is obtained from the mathematical sign sequence from the equation (3).

The section of the correlation sequence which is used to produce the correlation word is advantageously a complete signed basic sequence from the correlation sequence.

The sample values from which the data word is intended to be formed are preferably read from the data memory in one reading step in accordance with a reading rule. This measure may be advantageous in order to comply with real-time correlation requirements.

According to a further aspect of the invention, the data memory is in the form of a ring data buffer. A ring data buffer is distinguished by the data being read successively to predetermined memory blocks. As soon as data has been written to all of the memory blocks, the process of writing the data to the memory blocks is begun again from the start. In this case, data that has been read in previously is overwritten with new data. In order to avoid data loss, the data stored in the ring data buffer must be processed at the same speed at which new data is read to the ring data buffer.

In order to produce the correlation word from the sequence elements, the code generator can comprise a shift register.

Furthermore, the correlator unit may be based on a matched filter.

The device according to the invention may be implemented in a synchronization device, by means of which a mobile radio receiver is synchronized to a time slot structure and, in particular, to a frame structure of a radio signal received from a base station. The mobile radio system is in this case preferably based on the UMTS Standard.

The method according to the invention is used for carrying out a correlation process in a mobile radio system. In a first method step, a sequence of sample values from a received signal is stored in a data memory. In a second method step, addresses for reading a data word from the data memory are produced in accordance with a predetermined reading rule. In this case, the data word contains the sample values from one section of the sequence of sample values. The sequence of the sample values within the data word need not be the chronological sequence in which the sample values were recorded. In fact, the sequence of the sample values within the data word is governed by the sequence of the sample values within the section, the reading rule and the organization structure of the data memory. In a third method step, a correlation word is produced from a predetermined correlation sequence. The correlation word is obtained from the sequence elements in one section of the correlation sequence. The sequence elements are arranged in the correlation word in a sequence, which depends on the data word. Finally, in a fourth method step, the data word is correlated with the correlation word.

The method according to the invention has the same advantages as the device according to the invention. A considerable power saving for carrying out a correlation process in a mobile radio system can thus be achieved by means of the method according to the invention.

### BRIEF DESCRIPTION OF THE DRAWINGS

The invention will be explained in more detail in the following text, using examples and with reference to the drawings, in which:

FIG. 1 shows a schematic circuit diagram of an arrangement for reading a data word from a data memory.

FIG. 2 shows a block diagram of one exemplary embodiment of the device according to the invention.

FIG. 3 shows a schematic illustration of one exemplary embodiment of the data memory according to the invention.

FIG. 4 shows a schematic illustration of the process of reading data words from the data memory.

FIG. 5 shows a schematic illustration of the process of reading data words from the data memory, and the production of the corresponding correlation words by the code generator.

FIG. 6 shows a schematic illustration of the process of reading data words from a data memory, and the production of the corresponding correlation words, according to a further exemplary embodiment of the invention.

FIG. 7 shows an architecture for the data memory and for the code generator.

### DETAILED DESCRIPTION OF THE INVENTION

The present invention will now be described with reference to the drawings wherein like reference numerals are used to refer to like elements throughout. The illustrations and following descriptions are exemplary in nature, and not limiting. Thus, it will be appreciated that variants of the illustrated systems and methods and other such implementations apart from those illustrated herein are deemed as falling within the scope of the present invention and the appended claims.

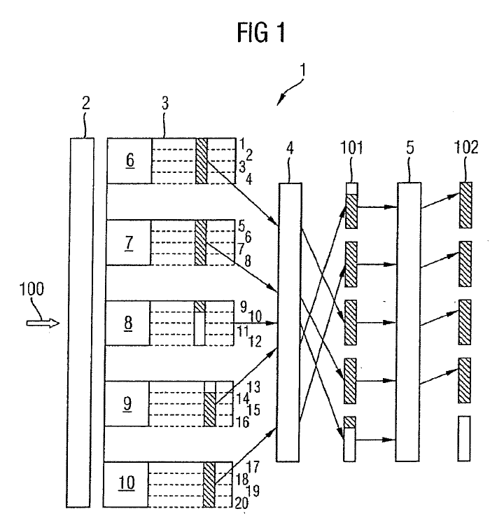

FIG. 1 shows the schematic circuit diagram of an arrangement 1 by means of which sample values 100 from a received signal can be temporarily stored, and can then be prepared for correlation processes to be carried out. The arrangement 1 comprises an input data buffer 2, a data memory 3, a multiplexer 4 and a shift register 5. Said components of the arrangement 1 are connected in series, in the sequence shown. The data memory 3 comprises five memory banks 6, 7, 8, 9 and 10. Each of the five memory banks 6 to 10 has four memory rows. The incoming sample values 100 are read to the data memory 3 by the input data buffer 2 selecting the memory banks 6 to 10 successively. In the process, four sample values are always written at the same time to one of the memory banks 6 to 10. As soon as a reading run with sample values being read to the memory bank 10 has been completed, the reading process is begun again from the start in the next column, so that the memory banks 6 to 10 are run through once again.

The multiplexer 4 reads the sample values from the data memory 3 sing a reading clock (from which a data word is intended to be formed for a subsequent correlation process). In the present case, one such data word 16 contains 16 sample values. By way of example, the sample values which are stored in the data memory 3 and from which a data word is intended to be formed for the subsequent correlation are shown on a grey background in FIG. 1.

In order to produce the data word, the multiplexer 4 reads a block, in each case comprising four sample values, from each memory bank 6 to 10. In this case, one block contains one column from one of the memory banks 6 to 10. Furthermore, the multiplexer 4 arranges the blocks in the sequence in which the sample values contained in the blocks were recorded.

The blocks 101 which have been read and sorted by the multiplexer 4 still contain four sample values which are not intended to be assigned to the data word, however.

The shift register 5 shifts the sample values in the blocks 101 through 1, 2 or 3 positions, so that the blocks 102 are formed, in which the uppermost four blocks contain the desired data word, and the lowermost block can be rejected.

The sorting operations which are carried out in the arrangement 1 by means of the multiplexer 4 and the shift register 5 include a major disadvantage of this arrangement. In the worst case, the data in the blocks 101 would have to be shifted cyclically through three sample values. In the case of a word length of, for example, 16 bits per sample value, all of the data in the blocks 101, for example 16*16 bits=256 bits, would have to be shifted 48 times. One such multiplexing and shift operation would have to be carried out for each newly read sequence element. Furthermore, an arrangement such as this is disadvantageous in comparison to an arrangement according to the invention, in terms of the power consumption and the area required.

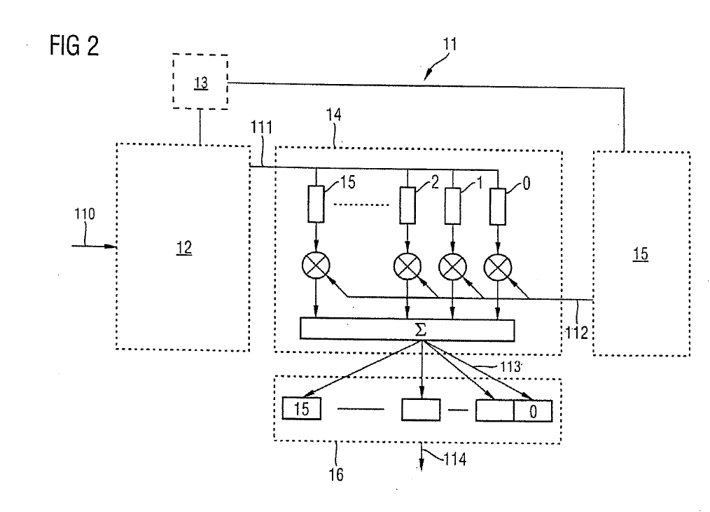

FIG. 2 shows a block diagram of a correlation device 11 as an exemplary embodiment in accordance with the present invention invention. The correlation device 11 comprises a data memory 12, an address generator 13, a matched filter (correlation unit) 14, a code generator 15 and a second data memory 16.

The correlation device 11 is used for synchronization of a mobile radio receiver to a time slot structure and/or frame structure of a radio signal received from a base station. In this example, the data transmission is based on the UMTS Standard.

Sample values 110 from a received signal are entered in the data memory 12, where they are temporarily stored. The address generator 13 defines the addresses of the sample values which are stored in the data memory 12 and which are intended to be read from the data memory 12 as a data word 111. The data word 111 is read to the matched filter 14, where it is correlated with a correlation word 112. The correlation word 112 is produced by the code generator 15 from the time slot synchronization code pSC or from the sequence z on which the frame synchronization code sSC is based, in accordance with the equation (3), below. The matched filter 14 emits a partial correlation value 113 as the result of the correlation of the data word 110 with the correlation word 112, and this is temporarily stored in the data memory 16. Correlation values 114 are emitted from the second data memory 16.

In the present exemplary embodiment, a data word 111 always comprises 16 sample values. The number of chips in a correlation word 112 is accordingly likewise 16. It is worthwhile carrying out the correlation processes in processing units which each have 16 sample values, since the basic sequences a and b for the time slot synchronization and frame synchronization in accordance with the below equations (2) and (4) each comprise 16 sequence elements.

In the case of time slot synchronization, the accumulation of 16 successively received partial correlation values 113 results in one correlation value 114. In consequence, a correlation value 114 is produced from 256 successively received sample values.

In the case of frame synchronization, the 16 successively received partial correlation values 113 are subjected to a 16-point Hadamard transformation. In consequence the 16 partial correlation values 113 are in this case not added up, and, instead, the correlation value 114 is emitted with a data length of 16 partial correlation values 113.

It should be noted that, in general, the signal received by the mobile radio receiver is sampled at twice the chip frequency. In order to obtain valid correlation values, only every alternate sample value may be used for a correlation process. A specific correlation process is carried out for the sample values located in between. For this reason, the sample values are read to different memory areas alternately. A distinction is thus drawn between sample values with odd and even indices. The matched filter 14 could, by way of example, process the two groups of sample values on a time-division multiplexed basis. However, only one group of sample values will be considered in the following text, for simplicity reasons. It is assumed that the successive sample values stored in the data memory 12 differ by one chip length.

It is noted that the correlation device 11 can be employed to compare incoming data, which is in the form of sampled received signals in the receiver, with a sequence of data items, which are known in the receiver, the predetermined correlation sequence. The partial correlation values and correlation values generated indicate, inter alia, whether the sequence of known data items in the received signal has been identified.

The correlation device 11, as stated above, can thus be employed for time slot and frame synchronization. Time synchronization between the base station and the mobile radio receiver is required in order to operate the mobile radio system. The synchronization of the mobile radio receiver that is typically required for this purpose is typically carried out, inter alia, when the mobile radio receiver is switched on or during a handover to a new cell. In this case, a distinction is drawn between time slot synchronization and frame synchronization. The aim of time slot synchronization is to find time slot boundaries. Once the time slot boundaries have been found, frame synchronization can be carried out. In this case, the start of a frame is looked for.

Predetermined synchronization codes or correlation sequence comprise a sequence of chips and are transmitted by each base station at the start of each time slot and are available in the mobile radio receiver and are employed for time slot synchronization and frame synchronization. The received synchronization codes, such as the data word 11, are correlated in the mobile radio receiver with the known synchronization codes, the correlation word 112. The time slot boundaries and frame boundaries are determined from the correlation results.

The time slot synchronization code, which is used for time slot synchronization, is also referred to as the primary synchronization code (pSC). The frame synchronization code, which is used for frame synchronization, is also referred to as the secondary synchronization code (sSC).

As an example, the UMTS (Universal Mobile Telecommunications System) Standard includes time slot synchronization code pSC comprised of 256 chips, and has the following structure:

$$\begin{matrix}\begin{matrix}pSC = < a , a , a , - a , - a , a , - a , - a , a , a , a , - a , a , - a , a , a > \\ = a < 1 , 1 , 1 , - 1 , - 1 , 1 , - 1 , - 1 , 1 , 1 , 1 , - 1 , 1 , - 1 , 1 , 1 >\end{matrix} & ( 1 ) \\ \begin{matrix}a = ( 1 + j ) < 1 , 1 , 1 , 1 , 1 , 1 , - 1 , - 1 , 1 , - 1 , 1 , - 1 , 1 , - 1 , - 1 , 1 > \\ ( 1 + j ) < a ( 0 ) , a ( 1 ) , a ( 2 ) , a ( 3 ) , a ( 4 ) , a ( 5 ) , a ( 6 ) , a ( 7 ) , a ( 8 ) , \\ a ( 9 ) , a ( 10 ) , a ( 11 ) , a ( 12 ) , a ( 13 ) , a ( 14 ) , a ( 15 ) >\end{matrix} & ( 2 )\end{matrix}$$

In this example, the complex-value basic sequence a is produced from a sequence of 16 correlation coefficients a(n) (n=0, 1, . . . , 15), which may each assume either the value +1 or the value −1. Each of the correlation coefficients a(n) represents one chip.

The time slot synchronization code pSC comprises a sequence of 16 sequence elements. Each sequence element is in turn based on the basic sequence, which is in each case multiplied either by +1 or by −1. In consequence, the time slot synchronization code pSC has a total of 256 correlation coefficients a(n) or chips.

According to the UMTS Standard, a frame synchronization code sSC comprises 256 chips. Each frame synchronization code sSC is obtained from positionwise multiplication of a generating Hadamard sequence by a sequence z which is common to all the frame synchronization codes sSC and is constructed as follows:

$$\begin{matrix}\begin{matrix}z = < b , b , b , - b , b , b , - b , - b , b , - b , b , - b , - b , - b , - b , - b > \\ = b < 1 , 1 , 1 , - 1 , 1 , 1 , - 1 , - 1 , 1 , - 1 , 1 , - 1 , - 1 , - 1 , - 1 , - 1 , >\end{matrix} & ( 3 ) \\ \begin{matrix}b = ( 1 + j ) < 1 , 1 , 1 , 1 , 1 , 1 , - 1 , - 1 , - 1 , 1 , - 1 , 1 , - 1 , 1 , 1 , - 1 > \\ = ( 1 + j ) < b ( 0 ) , b ( 1 ) , b ( 2 ) , b ( 3 ) , b ( 4 ) , b ( 5 ) , b ( 6 ) , b ( 7 ) , b ( 8 ) , b ( 9 ) , \\ = b ( 10 ) , b ( 11 ) , b ( 12 ) , b ( 13 ) , b ( 14 ) , b ( 15 ) >\end{matrix} & ( 4 )\end{matrix}$$

In this case, the complex-value basic sequence b is produced from a sequence of 16 correlation coefficients b(n) (n=0, 1, . . . , 15), each of which may assume either the value +1 or the value −1. Each of the correlation coefficients b(n) represents one chip.

The sequence z comprises a sequence of 16 sequence elements. Each sequence element is in turn based on the basic sequence b, which is in each case multiplied either by +1 or by −1. In consequence, the sequence z has a total of 256 correlation coefficients b(n) or chips.

The positionwise multiplication of the sequence z by 16 different Hadamard sequences each comprising 256 chips results in 16 different frame synchronization codes, each having 256 chips. The base station transmits one specific frame synchronization code in each time slot in a frame. The sequence of the frame synchronization codes is the same in each frame, for a given base station. The frame start can also be deduced from the pattern of frame synchronization codes, which thus results in each frame. Furthermore, this pattern is characteristic of each base station, and is thus also used to determine the base station transmitting the frame synchronization codes.

During the time slot synchronization process, the chips from the time slot synchronization codes arriving in the mobile radio receiver, or their sample values, are correlated with the known time slot synchronization code with the aid of a matched filter 14. The matched filter 14 carries out successive correlation procedures over 256 sample values in this example, with the offset between two successive correlation procedures corresponding, for example, to half the chip length. According to the UMTS Standard, one time slot contains 2560 chips, so that the matched filter normally calculates 5120 correlation values in each time slot.

After completion of the correlation processes, which are required for time slot synchronization, the correlations for frame synchronization are carried out. The start indices which resulted in the highest correlation values during the time slot synchronization process are used, for example, as the start indices for these correlation processes. Beginning with a start index, 256 sample values are multiplied positionwise by the sequence z for frame synchronization. In parallel with this, the sum is formed of the multiplication results from 16 successive sample values in each case, thus resulting in 16 partial correlation values. A partial correlation value corresponds to correlation of the 16 sample values processed in the partial correlation value with the basic sequence b on which the sequence z is based. The mathematical sign +1 or −1 by which the basic sequence b is multiplied as a function of its position in the sequence z must be taken into account in this process. Overall, in consequence for this example, this results in 16 complex-value partial correlation values for a start index.

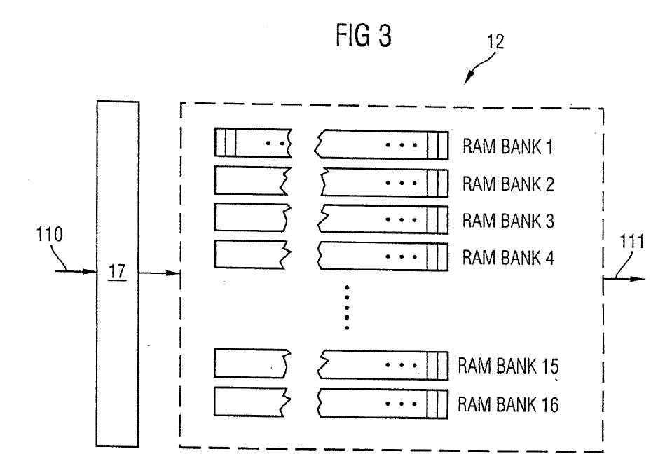

FIG. 3 shows a schematic layout of the data memory 12, as an exemplary embodiment of the data memory according to the invention. The data memory 12 comprises an input data buffer 17, and 16 downstream memory banks RAM BANK 1 to 16. 16 sample values with a word length of 16 bits each can be temporarily stored in the input data buffer 17.

Each of the memory banks RAM BANKs 1 to 16 contains a specific number of memory cells, in each of which one sample value with a word length of 16 bits can be stored. In the present case, it is assumed that the memory banks RAM BANKs 1 to 16 each contain 16 memory cells.

The sample values 110 which arrive in the data memory 12 are first of all temporarily stored in the input data buffer 17, and are then distributed between the memory banks RAM BANKs 1 to 16. In the process, the first sample value is written to the outer, right memory cell in the memory bank RAM BANK 1. The second sample value is then written to the memory cell, located underneath this, in the memory bank RAM BANK 2. As soon as the first column of memory banks RAM BANK 1 to 16 has been filled, the second column is filled, starting with the memory bank RAM BANK 1. This method is continued in a corresponding manner.

In the present case, the data memory 12 is a ring data buffer, which means that, as soon as all the memory cells have been filled with sample values, the process begins again from the start of filling the memory cells in the memory banks RAM BANKs 1 to 16 with new sample values, with the old sample values being overwritten in this way.

On the output side, the data word 111 is emitted from the data memory 12.

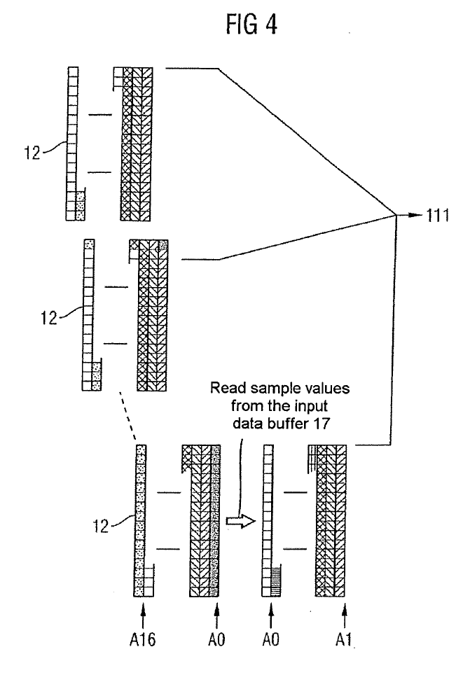

FIG. 4 shows, schematically and by way of example, the successive reading of data words 111 from the data memory 12 by way of a predetermined reading rule.

In the three illustrations of the data memory 12 shown in FIG. 4, the 16 sample values from each of which a data word 111 is intended to be formed are each shown with the same pattern. Fields on a black background contain data which has already been processed and is no longer required. Fields on a white background without any additional pattern can be overwritten by new data from the input data buffer 17.

In the uppermost illustration in FIG. 4, the sample values in the first, that is to say the right-hand column, of the data memory 12 form a data word 111. This data word 111 is read to the matched filter 14, where it is correlated with a correlation word 112. The sample values in the second column of the data memory 12 are then read as a data word 111, and are correlated. This procedure is continued until 16 data words 111, that is to say 256 sample values, have been read, and a first correlation value 114 can be produced in the data memory 16. The first correlation run is then complete.

Once the sixteenth data word 111 has been read in the first correlation run, a data word 111 is once again read from the first column of the data memory 12. However, this data word 111 has been shifted through one sample value in comparison to the first data word 111 in the first correlation run, so that the sample value from the second column of the memory bank RAM BANK 1 is also belongs to this data word 111. In a corresponding manner, the further data words 111 in the second correlation run are read in a corresponding manner from the data memory 12. This correlation run is shown in the central illustration in FIG. 4. In consequence, the second correlation run produces a second correlation value 114.

The described method is continued in a corresponding manner. The lowermost illustration in FIG. 4 shows the seventeenth correlation run. In this case, the first data word ill to be read in the correlation run has been shifted so far that it is completely located in the second column of the data memory 12. Since the sample values in the first column of the data memory 12 are now no longer required, they can be overwritten with new sample values from the input data buffer 17.

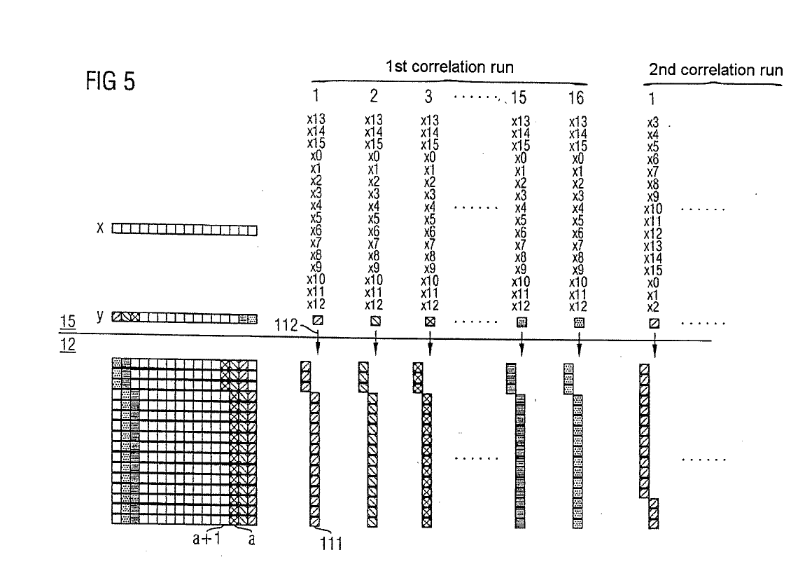

FIG. 5 shows how the data words 111 are read from the data memory 12, and how the corresponding correlation words 112 are produced by the code generator 15.

The data memory 12 is illustrated in the lower half of FIG. 5. Sample values which are each intended to form a data word 111 are once again identified by the same pattern. Sixteen data words 111 are shown, and these are read in a first correlation run. The first data word 111 is illustrated for the subsequent second correlation run.

In the first correlation run, those sample values which are each intended to form a data word 111 always extend from a memory cell in the memory bank RAM BANK 4 to the memory cell in the memory bank RAM BANK 3 in the next column. As can be seen, this can be described by an offset of 3 for the first correlation run.

The sample values in the data word 111 are not arranged in the chronological sequence in which they were read to the data memory 12. Their arrangement in the data word 111 can be illustrated by a projection of the sample values from the data memory 12 onto a vertical axis. For the present example, this means that the data word 111 is indicated by the three sample values which were located in the column with the column address a+1 in the data memory 12, and that the 13 sample values in the column with the column address a are arranged only after this.

In this case, it should be noted that a data word 111 is read from the data memory 12 in one reading step.

Since the sample values in the data word 111 are not arranged in their chronological sequence, the correlation word 112 is matched to the arrangement of the data word 111. In the end, the offset of the correlation word 112 and the offset of the data word 111 have to match. In the present case, this means that the basic sequence a or b must be reorganized appropriately by the code generator 15. The method of operation of the code generator 15 is illustrated in the upper half of FIG. 5. In this case, one basic sequence x which comprises 16 sequence elements [x0,x1, . . . ,x15] is used to represent the basic sequences a and b.

The basic sequence x is reorganized in the first correlation run in a corresponding manner to the arrangement of the sample values in the data word 111. This may be achieved, for example, with the aid of a shift register. In the end, this results in a basic sequence [x13,x14,x15,x0,x1, . . . ,x12] for the first correlation run.

For time slot synchronization and frame synchronization, the basic sequence also has to be multiplied by the mathematical sign sequences from the above equations (1) or (3). FIG. 5 shows a complementary sequence y, which contains the respective mathematical signs in its 16 sequence elements, as being representative of these mathematical sign sequences. In order to produce a partial correlation value 113, the reorganized basic sequence x is multiplied by the corresponding mathematical sign in the complementary sequence y, and this is then correlated with the corresponding data word 111.

FIG. 5 also shows the start of a second correlation run. In this case, the offset is 13. In consequence, the basic sequence x assumes the form [x3,x4, . . . ,x15,x0,x1,x2].

The procedure shown in FIG. 5 is advantageous because the sample values in the data memory 12 do not need to be reorganized before starting a new correlation run. All that is required is to use the shift register to match the basic sequence x to the sequence of the sample values in the data word 111. For the present exemplary embodiment, this means that, assuming that the correlation word 112 has a word length of 16 bits, the basic sequence x may be cyclically shifted by at most 15 bits. There is no need for any multiplexing operations. The basic sequence x remains constant throughout a correlation run. It is advantageous in this case that considerably fewer bit shift operations are required in comparison to the arrangement 1 in FIG. 1, and this results in a reduced power consumption.

The procedure according to the invention can also be applied to the data memory 3 illustrated in FIG. 1. Instead of using the multiplexer 4 and the shift register 5 to reorganize the sample values, the sample values are then arranged in the data word in the sequence which would have resulted from a projection onto a vertical axis. Zeros have to be inserted into the correspondingly reorganized basic sequence x for those sample values which do not belong to the desired data word.

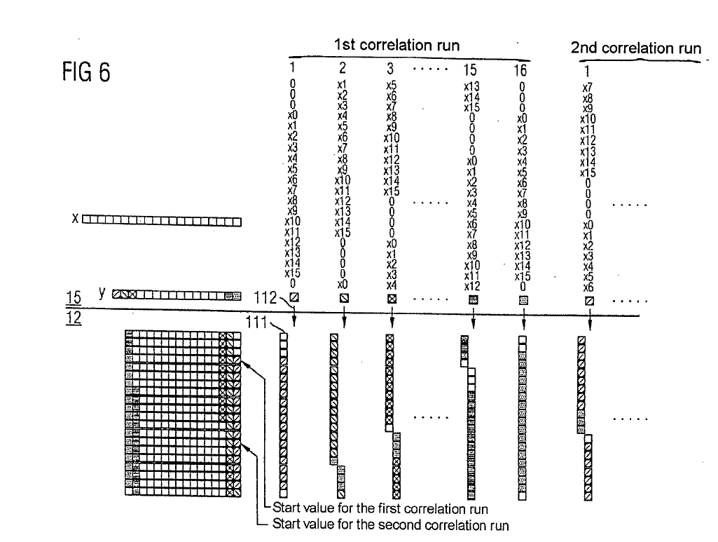

FIG. 6 shows one such procedure. The illustrations in FIG. 6 are largely analogous to those in FIG. 5, although the data memory 12 in FIG. 6 has five memory banks, each of which has four memory rows. Furthermore, FIG. 6 shows that the basic sequence x in the case of the present exemplary embodiment is no longer constant throughout a correlation run, but must be reorganized for each correlation element. In addition, zeros are inserted at the appropriate points into the basic sequence x. The procedure that is sketched in FIG. 6 is advantageous in comparison to the method of processing in the arrangement 1 shown in FIG. 1, since no multiplexing operations are required. With the present word length of the correlation word 112 of 20 bits, only a maximum cyclic shift of 19 bits is required for each correlation element.

As can be seen from the exemplary embodiments of the invention shown in FIGS. 5 and 6, the procedure according to the invention can be applied to different organization structures of the data memory 12. In this case, the number of memory banks and the number of memory rows in a memory bank may be varied as required. The respective organization structure of the data memory 12 must be observed in the arrangement of the basic sequence x for production of the partial correlation values. Furthermore, the reading rule must be observed, which, for example when prescribing a time slot synchronization and/or frame synchronization, specifies which sample values are processed in which step in a correlation run.

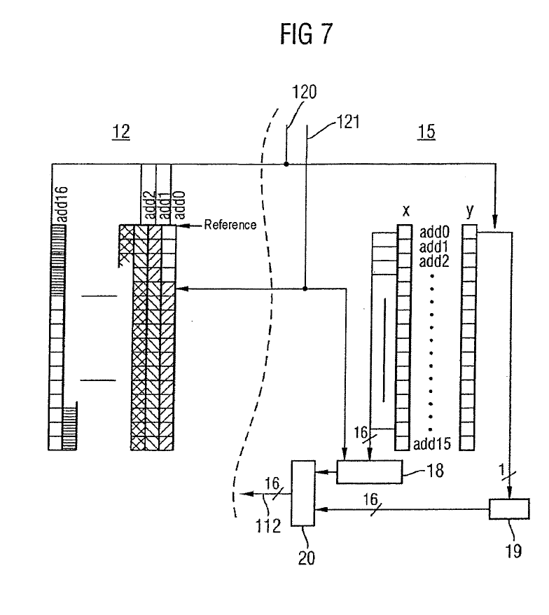

FIG. 7 shows an example of the architecture for the data memory 12 and for the code generator 15. In FIG. 7, the two components are separated graphically by a dashed line.

The architecture shown in FIG. 7 is suitable for carrying out the exemplary embodiment illustrated in FIGS. 3 to 5. The architecture can also be designed to carry out the exemplary embodiment as shown in FIG. 6, by slight modifications.

Both the data memory 12 and the code generator 15 are fed with monitoring signals 120 and 121. The monitoring signal 120 selects the column in the data memory 12 in which the chronologically first sample value for the data word 111 to be formed can be found. Furthermore, the monitoring signal 120 indicates that sequence element in the complementary sequence y which must be selected in order to form the correlation word 112. The monitoring signal 121 indicates the offset which, in the present case, is 5.

The monitoring signal 121 feeds address logic 18, which uses this information to produce the basic sequence x, shifted cyclically through the required offset. The sequence element selected by the monitoring signal 120 from the complementary sequence y is passed to a 1-to-16 bit converter 19, which converts the one bit mathematical sign to a 16 bit word. This is necessary in order that the mathematical sign from the complementary sequence y can subsequently be multiplied by the reorganized basic sequence x, by means of a multiplier 20, bit by bit. The multiplier 20 emits the correlation word 112 on the output side.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

1. A device for carrying out a correlation in a mobile radio system comprising:
a data memory that stores a sequence of sample values of a received signal;
an address generator that produces addresses for reading a data word from the data memory in accordance with a predetermined reading rule, wherein the data word comprises sample values of a section of the sequence of sample values, wherein the address generator determines a sequence for the sample values within the data word according to the sample values within the section, the predetermined reading rule, and organizational structure of the data memory;
a code generator that produces a correlation word from sequence elements in a section of a predetermined correlation sequence, wherein the sequence elements are arranged in the correlation word according to the data word; and
a correlator unit that correlates the data word with the correlation word.

2. The device of claim 1, wherein the data memory comprises M separately addressable memory elements.

3. The device of claim 2, wherein the M separately addressable memory elements operate sequentially and cyclically for storage of the sample values, wherein N successively recorded sample values are stored in each of the M separately addressable memory elements.

4. The device of claim 1, wherein the predetermined correlation sequence is based on a basic sequence.

5. The device of claim 4, wherein the basic sequence is executed cyclically, starting at one sequence element in order to produce the correlation word.

6. The device of claim 1, wherein the data word has M sample values, the data memory comprises M memory elements, the predetermined correlation sequence has M sequence elements, and wherein the address generator allocates one sample value from each memory element to the data word.

7. The device of claim 1, wherein the data memory comprises M memory elements numbered successively on an imaginary bases, wherein the sample values in the data word are each allocated to one of M data word unit elements numbered successively on an imaginary basis, wherein the address generator presets a start address X in order to read the data word in accordance with the reading rule, wherein the start address X denotes one of the M memory elements, wherein the data word subunits X to M are assigned sample values from the memory elements X to M, wherein the data word subunits 1 to X-1 are assigned sample values from the memory elements 1 to X-1, and wherein the sample values assigned to the data word subunits have been recorded in the sequence X, . . . , M, 1, . . . , X-1.

8. The device of claim 1, wherein the correlation word has M sequence elements numbered successively from one to M, wherein the sequence elements are individually allocated to correlation word subunits, wherein the correlation word subunits are numbered successively on an imaginary basis from 1 to M, wherein values for the correlation word subunits X to M are produced from sequence elements 1 to M-(X-1) and values for the correlation word subunits 1 to X-1 are produced from sequence elements M-(X-1)+1 to M.

9. The device of claim 1, wherein the data memory is a ring buffer.

10. A correlation device comprising:
a data memory that stores a sequence of sample values of a received signal;
an address generator that defines a data word comprised of sample values of the sequence of sample values according to a reading rule, determines an arrangement of the sample values within the data word according to the reading rule, and produces addresses for the sample values within the data word in accordance with the determined arrangement;
a code generator that receives the addresses for the sample values within the data word, produces a correlation word from sequence elements of a predetermined correlation sequence and determines a correlation arrangement of the correlation word according to the determined arrangement by the address generator; and
a correlator unit that receives the data word from the data memory and the correlation word from the code generator and generates a partial correlation value of the data word and the correlation word.

11. The device of claim 10, wherein the predetermined correlation sequence is frame synchronization code.

12. The device of claim 10, wherein the predetermined correlation sequence is time slot synchronization code.

13. The device of claim 10, wherein the correlator unit further generates a correlation value by combining the partial correlation value with previous partial correlation values.

14. The device of claim 10, wherein the reading rule prescribes a time slot synchronization that specifies which sample values are processed.

15. The device of claim 10, wherein the reading rule prescribes a frame synchronization.

16. A method for performing correlation comprising:
storing a sequence of sample values from a received signal;
selecting a plurality of sample values from the sequence of sample values as a data word according to a reading rule;
determining an arrangement of the plurality of sample values at least partially according to the reading rule;
generating a correlation word from a predetermined correlation sequence;
determining an arrangement of chips within the correlation word according to the arrangement of the plurality of sample values within the data word; and
correlating the data word with the correlation word to generate a partial correlation value.

17. The method of claim 16, further comprising accumulating the partial correlation value with previous partial correlation values to obtain a correlation value for time slot synchronization.

18. The method of claim 16, further comprising combining the partial correlation value with previous partial correlation values to obtain a correlation value for frame synchronization.

19. The method of claim 16, further comprising subjecting the partial correlation value with previous partial correlation values to a Hadamard transformation.

20. The method of claim 16, wherein determining the arrangement of the plurality of sample values is performed further according to a chronological sequence of the plurality of sample values.

21. The method of claim 16, wherein determining the arrangement of the plurality of sample values comprises selecting an offset value and wherein determining the arrangement of the chips within the correlation word employs the selected offset value.

22. The method of claim 16, wherein the reading rule specifies the plurality of samples selected according to a time slot synchronization.
